(19) United States
(12) Patent Application Publication
(10) Pub. No.: US 2026/0018396 A1
(43) Pub. Date: Jan. 15, 2026

(54) METHOD AND APPARATUS FOR DETECTING PARTICLES IN A GAS OF A PROCESS ENVIRONMENT AS WELL AS A COATING SYSTEM WITH SUCH AN APPARATUS

(71) Applicant: INFICON AG, Balzers (CH)

(72) Inventors: Urs WÄLCHLI, Chur (CH); Michael F. VOLLERO, Manlius, NY (US); Huidong ZANG, Manlius, NY (US); Niall Sean MACGEARAILT, Dublin (IE); Christian RIESCH, Bürs (AT); Mohamed RINZAN, Manlius, NY (US)

(21) Appl. No.: 19/099,020

(22) PCT Filed: Jul. 26, 2022
(86) PCT No.: PCT/US2022/038389

§ 371 Date: Jan. 27, 2025

(51) Int. Cl. H01J 47/04; H01J 47/02

(52) U.S. Cl. CPC H01J 47/04; H01J 47/026

(57) ABSTRACT

A method for detecting particles in a gas of a process environment present in a process chamber, the method comprising the steps of: guiding the gas with the particles into an ionization and charging unit (11) being in fluid communication with the process chamber, wherein the ionization and charging unit has an anode (12) and a cathode (13) and is adapted and configured to at least partly ionize said gas and to charge at least some of said particles; igniting and sustaining a discharge in said gas by applying a voltage between said anode and said cathode of the ionization and charging unit; measuring a current flowing from or to the anode and/or from and to the cathode; detecting the particles based on an AC component or a transient of the measured current. The invention is further directed to an apparatus for detecting particles, to a coating system comprising such an apparatus and to a use of ionization unit.

### TECHNICAL FIELD

The present invention pertains to a method for detecting particles, such as “large molecules” for instance having a mass of more than 1000 Dalton and up to micrometre-sized particles, in a gas, for example air, of a process environment. The ambient pressure at which the detection takes place is in particular less than atmospheric pressure. Furthermore, the present invention relates to an apparatus for implementing the inventive method as well as a coating system comprising such an apparatus.

### BACKGROUND OF THE INVENTION

In applications in the semiconductor industry, for example, if particles are present in a process step, they can land on the silicon wafer and adhere. In later steps, these particles are for instance incorporated into a functional layer being manufactured and cause it to malfunction. Such a functional layer may for example comprise transistors. So, in order to achieve a desired yield, the number of particles (and their size distribution) should be monitored. This is typically done on the pump side of the system. A sensor is located there and monitors the particles in the gas coming from the process chamber. If a change towards an inacceptable concentration of particles is detected, then the process is stopped, and the cause may be determined.

Techniques for detecting and measuring particles in gases with the help of light are well established. Descartes originally disclosed the principle of optical detection of particles in gas in 1637. A different approach to the determination of particles is mass spectrometry, which has proven itself as an analytical instrument for many applications, including the measurement of relatively small particles (e.g. having a mass of less than 1,000,000 Dalton) in many applications. Mobility spectrometers, often called ion mobility spectrometers (IMS), originated in the 1950's. Their size is substantially smaller than mass spectrometers.

These state-of-the-art devices have the following disadvantages:
The optical instruments always require windows or lenses which are exposed to the medium to be measured, at least on one side. This makes a design inherently complex and susceptible to contamination, which in turn leads to even more complex designs. For the measurement of smaller particles, strong light sources are preferred, which then requires special safety measures for the operation of these light sources. Another drawback of applying light sources emitting increased light intensity is that background signal increases as well, such that no net win may result.
Mass spectrometers are very complex, large devices, which are also very expensive and usually need additional vacuum chamber with corresponding pump equipment. Moreover, they are not always easy to handle.
The use of mobility spectrometers only works under constant environmental conditions such as constant gas composition and constant ambient pressure or constant flow conditions in the drift tube. Even small traces of, for instance, water or acetone lead to a complete change of the chemistry in the drift tube. If this is not the case in the application (as is true with many process systems), then their use becomes expensive because the pressure stability and gas type stability should first be established in the analysis section.
Consequently, there exists a need for means to detect particles in a gas which overcome the disadvantages of the stated known devices.

### SUMMARY OF THE INVENTION

It is an objective of the present invention to provide a simple method for detecting particles, such as “large molecules” for instance having a mass of more than 1000 Dalton, in a gas, for example air, of a process environment. This objective is reached by the method specified in claim 1.

Particles can be detected in a gas based on the following principle. The particles are ionized by bombarding the particles with electrons having a kinetic energy of some electron volts, leading to impact ionization of the particles. Depending on the type of particle, positively charged particles, i.e. electrons are missing, or negatively charged particles, i.e. electrons have been added, are produced. Metallic particles are more positively charged and insulating particles are more negatively charged. In vacuum coating applications the composition of the particles is a complex matter, as they are mostly formed relatively uncontrolled in physical chemical processes at energies relatively high compared to 1/40 eV. Only in the case of abrasion in moving parts (e.g. in the case of valve movements or robot arm movement), the particles are of clear material composition. The charged particles are then accelerated in an electric field. The strength and direction of the electric field drive the movement of the particles. Preferably, the electric fields present in the ionization and charging unit are configured such that the particles reach an energy above 50 eV before they hit an electrode. To achieve this, high voltages (>100 V) are preferable. The acceleration by the electric field provides to the particles the energy and momentum needed in the next step. The particles then strike a metallic anode or cathode, depending on the charge of the particles. Two things happen in the process. First, the particles try to neutralize their electric charge, and second, the force of the impact (momentum of the particle) creates secondary electrons and, at high energies, secondary ions and neutrals. The charge of the electrode onto which the particles impact changes due to the mentioned three influences, i.e., neutralization, secondary electrons and secondary ions. The charge currents to and from the electrodes, i.e., to and from anode or cathode, respectively, are measured and indicate the impact and based on the signature of the current also the class of the particle.

Based on this principle, the method for detecting particles in a gas of a process environment within a process chamber, in particular of a coating system, according to the present invention comprises the steps of:
guiding the gas with the particles into an ionization and charging unit being in fluid communication with the process chamber, wherein the ionization and charging unit has an anode and a cathode and is adapted and configured to at least partly ionize said gas and to charge at least some of said particles;
igniting and sustaining a discharge in said gas by applying a voltage between said anode and said cathode of the ionization and charging unit;
measuring a current flowing from or to the anode and/or from and to the cathode;
detecting the particles based on an AC (alternating current) component or a transient of the measured current.

The gas of the process environment, in which a particle concentration is to be monitored, may e.g. be the gas in a process chamber of a coating system. The gas may be any process gas or an inert gas, such as nitrogen, oxygen, hydrogen, helium or argon. The gas potentially carries with it one or more particles but may as well be a clean gas containing no particles at all. The method may be used to verify that the gas is clean in this sense.

The ionization and charging unit may e.g., be built such that a continuous discharge is possible. This may e.g. be achieved by providing a combination of an electric field and a magnetic field in the interior of the ionization and charging device, which combination of fields acts on electrons in such a way that they move on a path having a length longer than a straight line between electrodes of opposite polarity. The electric and magnetic field provided may have a strength and be geometrically arranged such that the kinetic energy of electrons may be kept in the range of 0-200 eV. E.g., an anode, a cathode and means for generating a magnetic field may have a cylindrical symmetry and provide an electrical field in a radial direction and a magnetic field in a longitudinal direction of the cylindrical arrangement. This way, the vector product of the electric and the magnetic field points in azimuthal direction of the cylindrical arrangement and a path following the direction of this vector product forms a closed loop. Configurations of electrical and magnetic fields having these properties are known from cold cathode gauges, in particular, from cold cathode gauges in form of a magnetron, an inverted magnetron or a Penning gauge. The inventors have recognized that electrode configuration and means for generating a magnetic field may be readily transferred from a cold cathode gauge to the ionization and charging device of the present invention.

The fluid communication between the process chamber and the ionization and charging unit may be established in that the ionization and charging unit is located within a delivery pipe for delivering the gas to the processing chamber or is located within a discharge pipe for discharging the gas from the process chamber. The ionization and charging unit may be dimensioned such that a significant part of the cross section of a discharging pipe having a diameter in the range of 40-100 millimetres is covered by cross section of the ionization and charging unit located within the discharge pipe. The ionization and charging unit may be placed upstream to pumping means, in particular, it may be placed immediately in front of pumping means, when seen in direction of a gas flow path.

Depending on the geometry of the anode and the cathode, igniting and sustaining a discharge may require higher or lower voltage. Typically, an electric field strength in the order of several hundreds of kilo volts per meter (kV/m) is applied. A magnetron may have dimension leading to a distance between electrodes of about 15 millimetres, and voltages in the order of 5 kV between the electrodes are applied, such that electrical field strength of approximately 300 kV/m are present in the magnetron. Small radii of a tip of an electrode or a small diameter of an electrode in form of a wire are geometric properties that locally increase the electric field at given voltage.

The igniting and sustaining a discharge in the gas may be achieved by applying a high constant voltage (DC) between the anode and the cathode of the ionization unit. Alternatively, an oscillating voltage (AC) may do the job, provided that half an oscillation period is long enough compared to the travel time of the charged particles from electrode to electrode. In an ionization and charging unit having dimensions in the order of centimetres, a frequency of oscillation of the voltage may be in the kilohertz range or below. A voltage suitable to achieve this may in particular be in the range from 100 V to 3 kV for a sensor having an electrode distance in the range 1-2 centimetres. Such a voltage is high enough to lead to enough impact that eventually charges the particles. Ignition voltages up to 6 kV may be applied, to make sure that a discharge is ignited under most circumstances. Once a discharge has been ignited, the voltage applied between the anode and the cathode serves to maintain a circulating electron current in the at least partly ionized gas. In a low-pressure environment, an RF-voltage of a few volts may suffice to sustain the discharge. A superposition of a low RF voltage and a high-voltage DC may be used to increase the discharge current flowing in the residual gas.

The inventors have recognized that a variation of the method allows to determine the pressure of the gas in addition to monitoring particles, by changing the voltage applied between the anode and the cathode and observing the change of discharge current resulting from changing the voltage. A DC current proportional to pressure may result, or, in case that a cold cathode is operated outside the proportional regime, at least a signature for the pressure may result from observing the discharge current. Thus, according to the variant of the method, a lower frequency AC component, e.g. in the kHz frequency range, may be observed to derive a pressure related information, and a higher frequency AC component, e.g. in the MHz frequency range, may simultaneously by observed to detect particles.

Variants of the method result from the features of dependent claims 2 to 10.

In a variant of the method, it further comprises the step of classifying the particles based on a signature of the AC component or of the transient of the measured current.

A signature of the AC component or of the transient of the measured current may be a single one out of the following features or a combination of the following features:
Signal amplitude leaving a noise band,
Signal amplitude exceeding a trigger level, i.e. overshoot/undershoot over/under a given threshold,
Integral of the absolute value of the signal over a time interval exceeds a threshold value,
Steepness of the signal slope after exceeding a trigger level,
A sign change of the signal,
A pattern of sign changes of the signal (e.g. + − +),
A peak of a duration shorter than a predetermined time,
A minimum number of oscillations in a predefined short time interval (e.g. in a time interval of 500 nanoseconds or of 5 microseconds after first exceeding a trigger level)
Asymmetric pattern in time, e.g. a decaying oscillation,
A characteristic frequency in the Fourier-transformed signal.

In a variant of the method, the particles to be detected have a mass of more than 1000 Dalton.

Dimensions of the ionization and charging unit, voltages applied, as well as trigger levels and the selection of signatures evaluated may be adapted such that only particles above a mass of more than 1000 Dalton are detected by the method. The particles to be detected typically have a size below 1 μm, but may have larger size as well.

In a variant of the method, an electric field between the anode and the cathode has a strength in the range from 300 to 3000 kilovolts per meter (300 to 3000 kV/m).

In a sensor having a distance between the anode and the cathode of 1 cm and wherein a voltage of 5 kV is applied between anode and cathode, an electric field strength of 500 kV/m is reached.

In a variant of the method, the gas is focussed into an opening of the ionization unit by means of a hydrodynamic lens. Optionally, the hydrodynamics lens may be heated to a temperature above the temperature of its surrounding.

In a variant of the method, the ionization and charging unit has an inlet at one end and an outlet at the other end, so that the gas can pass through the ionization and charging unit.

The ionization and charging unit may have tubular form. This form may e.g. be realized by electrodes in form of a hollow cylinder as cathode and a pin shaped anode placed on the central axis of the cylinder. The form of the ionization and charging unit may have conical sections and have circular, quadratic or rectangular cross section. The form may be adapted to cover a large fraction of the cross section of a pipe, in which the gas flow is to be monitored for the presence of particles.

In a variant of the method the gas is in the group comprising air, nitrogen, oxygen, hydrogen, helium and argon.

The variant, in which the gas is air may be applied when a process chamber is evacuated after an exposure to surrounding atmosphere. For semiconductor manufacturing, the gases nitrogen, oxygen, hydrogen, helium and argon are required for specific functions in the manufacturing process.

In a variant of the method, a pressure of the gas, at which pressure the detection takes place, is less than atmospheric pressure, in particular down to 10⁻⁸ mbar.

Means for igniting and sustaining a discharge in the gas may be adapted to a pressure range in the medium vacuum range or the high vacuum range, by suitable electrode geometry, additional magnetic fields and the selection of the voltage applied to the electrodes, such that said gas is at least partly ionized at the pressure at which the detection takes place.

In a variant of the method, the step of detecting comprises amplifying the charging current and/or the discharging current by means of an AC amplifier circuit having a bandwidth of at least 500 MHZ (Megahertz).

The amplifier circuit used for this variant of the method can be considered as a very fast amplifier circuit being able to handle signals of a short time scale in the nanosecond range. The amplifier circuit may be based on an active component, such as an operational amplifier (opamp), with a gain-bandwith-product above 500 MHZ. The amplifier circuit may be configured to operate as voltage follower or buffer amplifier. Thus, the amplifier circuit may have a voltage gain of 1 or even slightly less. Such a buffer amplifier prevents the signal source from being affected by the currents required on the output side of the amplifier circuit.

In a further variant the method comprises the step of indicating that particles have been detected when the AC component or the transient exceeds a predetermined threshold, and/or indicating that a certain class of particles has been detected when an associated signature has been detected.

In particular, the method may comprise the step of indicating when an associated signature from one or more predetermined signatures of the AC component or of the transient has been detected. Possible signatures may be selected from the list discussed above.

It is a further goal of the present invention to provide an alternative apparatus for detecting particles, such as “large molecules” for instance having a mass of more than 1000 Dalton, in a gas, for example air, of a process environment. More specifically, a simpler, smaller and cheaper apparatus for the purpose of detecting particles is desired. This objective is reached by the apparatus specified in claim 11.

The apparatus according to the invention is an apparatus for detecting particles in a gas of a process environment in a process chamber. The apparatus comprises:
an ionization and charging unit with an anode and a cathode, adapted and configured to at least partly ionize said gas and to charge at least some of said particles;
a voltage source connected between said anode and said cathode of the ionization and charging unit;
a current measurement unit adapted to measure a current from or to the anode and/or from and to the cathode;
a particle classification unit adapted to detect the particles based on an AC component or a transient of the measured current.

The ionization and charging unit may-as discussed in the context of the method-be built such that a continuous discharge is possible. This may e.g. be achieved by an arrangement of electrodes and magnets similar to a cold cathode gauge, in particular, in form of a magnetron, an inverted magnetron or a Penning gauge.

The voltage source may e.g. be adapted to deliver a DC voltage in the range from 100 V to 10 kV. The voltage source may e.g. be adapted to deliver a superposition of AC and DC voltage and may in particular be adapted to be controlled to perform steps of the method as discussed above. In combination, the voltage source and the geometry of the electrodes may be adapted to generate an electric field with several hundreds of kilo volts per meter (kV/m) in the interior of the ionization and charging unit.

Components of the apparatus, in particular the anode, the cathode, and, if an embodiment comprising a hydrodynamic lens is concerned, the hydrodynamic lens, may be constructed of an alloy of the group comprising Hastelloy, Inconel or stainless steel, more generally, iron based alloy having a nickel content above 10% and a chromium content above 10%. These materials are compatible with semiconductor processes. To achieve a long lifetime of the electrodes it is particularly useful to select a material having very low sputter yield. The inventors have recognized that molybdenum, titanium and high-grade stainless steels are suitable materials for the components of the apparatus.

The apparatus may comprise heating means, which heating means may be adapted to heat the apparatus or components of the apparatus up to a temperature above the temperature of the surrounding to avoid deposition of substances on the surface of the hydrodynamic lens. A temperature that may be useful to achieve this goal may be in the range from 80° C. to 300° C., in particular around 200° C. The heating means may be adapted to keep the temperature below a predefined temperature limit, e.g., below 150° C., to protect neighbouring elements, which do not tolerate a higher temperature. Some ALD or CVD processes may require a heating to a temperature of 300° C. in order to prevent deposition of substances onto the apparatus. The apparatus may be built to heat itself by means of the discharge current flowing in normal operation, i.e. in sustaining the discharge in the gas, and by minimizing heat drain to other components, e.g. in that mechanical connections to the surrounding have small cross sections.

Specific embodiments of the apparatus according to the present invention are given in the dependent claims 12 to 18.

In an embodiment of the apparatus, the particle classification unit is further adapted to classify the particles based on a signature of the AC component or of the transient of the measured charging current and/or the discharging current. Possible signatures are discussed above in the context of a variant of the method.

In an embodiment, the apparatus is designed and configured to detect particles that have a mass of more than 1000 Dalton. The particles to be detected typically have a size below 1 μm, but may have larger size as well.

In an embodiment, the apparatus is adapted such that an electric field between the anode and the cathode can have a strength in the range from 300 to 3000 kV/m.

In an embodiment, the apparatus further comprises a hydrodynamic lens adapted to focus the gas into an opening of the ionization and charging unit. Optionally, the hydrodynamics lens is in thermal contact to heating means for increasing the temperature of the hydrodynamic lens with respect to its surrounding. In particular, the heating means may be adapted to heat the hydrodynamic lens up to a temperature in the range from 80° C. to 300° C. to avoid deposition of substances on the surface of the hydrodynamic lens. Issues discussed above in the context of heating the apparatus apply to heating the hydrodynamic lens, as well.

In an embodiment of the apparatus, the ionization and charging unit has an inlet at one end and an outlet at the other end, so that the gas can pass through the ionization and charging unit. The ionization and charging unit may have tubular form.

In an embodiment, the apparatus further comprises an amplifier circuit for amplifying the charging current and/or the discharging current, wherein the amplifier circuit having a bandwidth of at least 500 MHz. The amplifier circuit may have features as discussed above in context of the method.

In an embodiment, the apparatus further comprises an output for a signal indicating that particles have been detected when the AC component or the transient exceeds a predetermined threshold, and/or indicating that a certain class of particles has been detected when an associated signature, in particular from one or more predetermined signatures, of the AC component or of the transient has been detected.

Further in the scope of the invention is a coating system, etching system or lithographic system according to claim 19.

The inventive system comprises the inventive apparatus and a processing chamber, where, depending on the type of system, coating, etching or lithographic processes can be performed. The system may comprise a delivery pipe for delivering the gas to the processing chamber or a discharging pipe for discharging the gas from the process chamber. The process chamber is the space where a coating process, an etching process or a lithographic process takes place. The apparatus according to the invention may in particular be located within the delivery pipe or within the discharging pipe, in particular upstream to a pumping arrangement.

In an embodiment, the coating system, etching system or lithographic system as discussed above, is adapted to perform CVD (chemical vapor deposition), PVD (physical vapor deposition), PECVD (plasma enhanced chemical vapor deposition) or ALD (atomic layer deposition) processes or the coating system is an epitaxy system.

The inventors have recognized that the detection or monitoring of particles may be done in an efficient and reliable manner by building the inventive apparatus into a system of the mentioned types, in particular into a coating system applying CVD, PVD, PECVD, ALD or epitactic coating.

Even further in the scope of the invention is the use of an ionization unit as defined in claim 21. The ionization unit may e.g. be a cold cathode pressure gauge, e.g. of the magnetron or inverted magnetron type or of the Penning type. According to the invention, an ionization unit is used for detecting particles in a gas of a process environment within a process chamber, wherein the particles to be detected in particular have a mass of more than 1000 Dalton. The inventors have recognized that ionization units known for other purposes may be used to perform the method according to the invention and have the role of the ionization and charging unit according to the method, i.e. being used for ionizing the gas that carries with it particles and to charge the particles, as well.

In a variant, the use of the ionization unit refers to a situation, wherein the ambient pressure at which the detection takes place is less than atmospheric pressure, in particular down to 10⁻⁸ mbar.

In a further variant of the use of the ionization unit, the gas is in the group comprising air, nitrogen, oxygen, hydrogen and argon.

Coming back to the configuration of a whole system, in which the present invention is implemented, a multiplicity of ionization and charging units may be operated simultaneously to monitor the presence of particles. Two or more ionization and charging units may be arranged in series along a direction of the gas flow. Two or more ionization and charging units may be arranged in parallel. A bundle of several ionization and charging units, e.g. realized in the form of cold cathodes, may be arranged in a tube having a diameter exceeding 100 mm.

### BRIEF DESCRIPTION OF THE DRAWINGS

The invention shall now be further exemplified with the help of figures. The figures show:

FIG. 1 a cross sectional view across central components of an embodiment of the apparatus;

FIG. 2 a cross sectional view across central components of another embodiment of the apparatus;

FIG. 3 a cross sectional view perpendicular to the views shown in FIGS. 1 and 2 of an embodiment of the apparatus;

FIG. 4 a circuit diagram showing an amplifier circuit of an embodiment of the apparatus;

FIG. 5 a schematic time dependency of a voltage signal indicative for a current measured in the method;

FIGS. 6 to 8 simplified and schematic examples of a voltage signal indicative for a current measured in the method.

### DETAILED DESCRIPTION OF THE INVENTION

Advantageous effects of the present invention are that the proposed method and apparatus for particle detection are simple and robust. It can be used in most coating systems like CVD, PVD and ALD as well as epitaxy. It further can be used in etching systems. The ion sources proposed above work very reliably up to a few mbar. At low pressures (<10⁻⁸ mbar) sustaining a discharge may become difficult.

Compared to all optical processes, there is no need for optical elements like viewing windows or mirrors for beam extension, which could change under the processes. Cold cathode gauges operating under the E×B−principle, such as magnetrons, inverted magnetrons or Penning gauges, sputter themselves clean in most applications. In very harsh applications, the devices according to the invention can easily be designed such that they can be heated up to 150° C., or even as high as 300° C., to avoid any deposition or other unwanted change of the electrode surfaces. Compared to mass spectrometers or similar equipment, a magnetron, inverted magnetron or Penning gauge is much simpler to set up and operate.

Commercially, due to the robustness and simplicity of the design, it becomes possible to enter application areas where previously no particle monitor was used online/in situ.

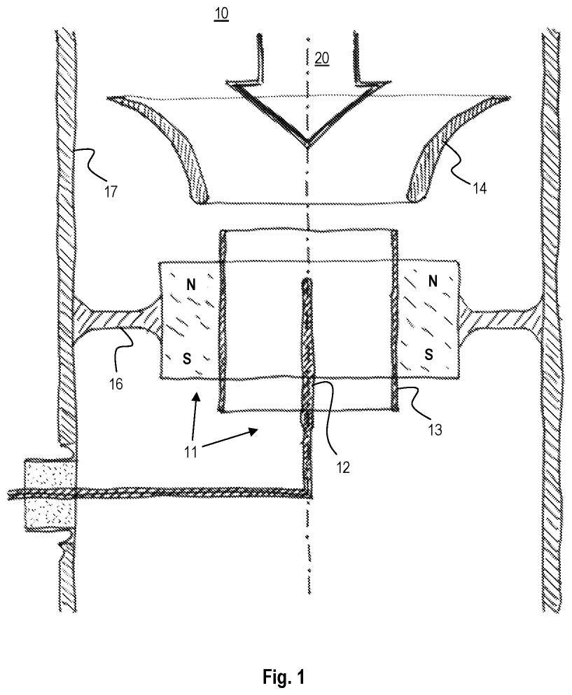

FIG. 1 shows a cross sectional view across central components of an apparatus, in which features of several of the embodiments discussed above are combined. On the top side an inflow of gas 20 is indicated by an arrow. This gas flow comes from a process chamber or is led to a process chamber by means establishing a fluid communication not shown in the figure. The embodiment shown here comprises a hydrodynamic lens 14, which concentrates the gas flow onto an inlet side of a tube-shaped cathode 13. An anode pin 12 is placed on a central axis of the cylindrical cathode 13. Anode 12, cathode 13 and magnets, indicated by south pole S and north pole N, placed outside the cathode, together form a ionization and charging unit 11, which is adapted and configured to at least partly ionize the gas. During this process, particles carried along with the gas are charged. The ionization and charging unit in the embodiment shown has the form of a magnetron. Different from a pressure gauge of the magnetron type, this ionization and charging unit has an inlet and an outlet opening and opposing ends, such that a gas flow across the ionization and charging unit is possible. The cross-section cuts through an electrical contact of the anode, which led through an isolated feedthrough to the outside of the pipe in which the ionization and charging unit is arranged. Anode pin 12, cathode 13, hydrodynamic lens 14 and the pipe 17 may have rotational symmetry with respect to the central axis indicated as dash-dotted line. Webs 16 hold the ionization and charging unit centered in the pipe 17. The webs 16 do not extend around the complete circumference, such that a gas flow radially outside of the cathode but still inside the pipe 17 is possible.

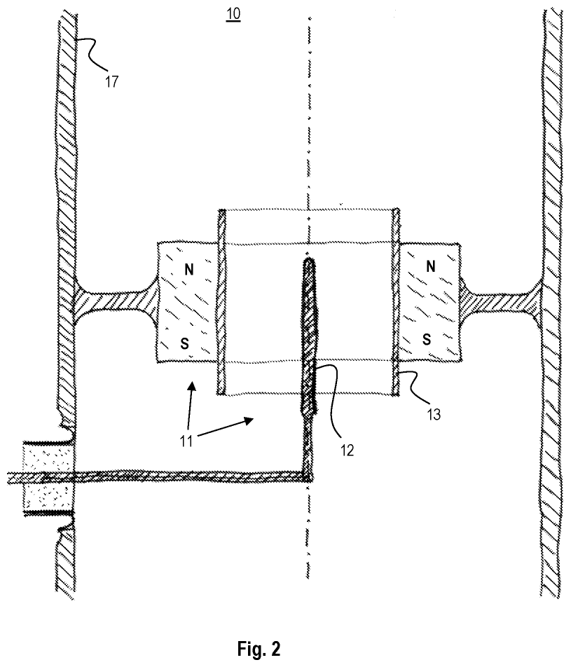

FIG. 2 shows a cross sectional view across central components of another embodiment of the apparatus, having similar components as the one shown in FIG. 1, but does not have a hydrodynamic lens.

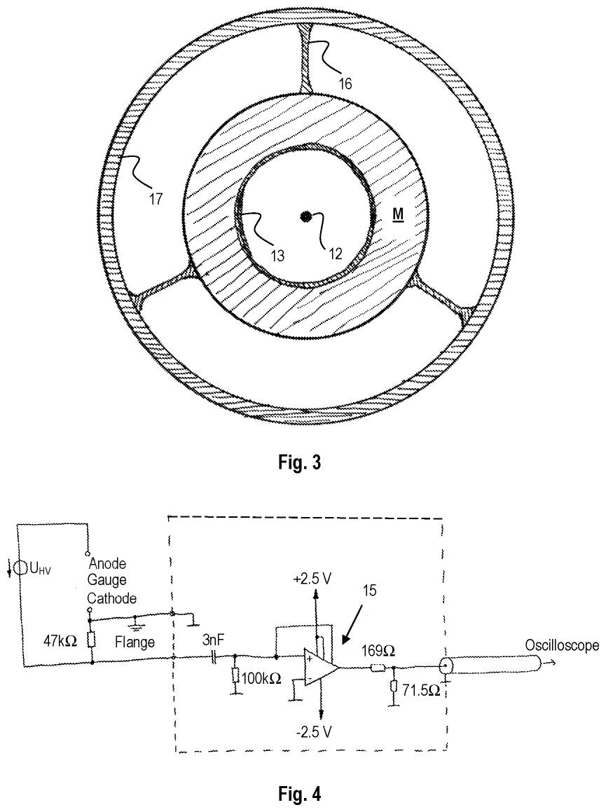

FIG. 3 shows a cross section through a variant similar to the ones shown in FIGS. 1 and 2, with only three webs 16 of small cross section holding a cathode 13 inside the pipe 17. A permanent magnet arrangement M is positioned radially outside the cathode and creates a magnetic field inside the cathode. An anode pin 12 is centrally placed, such that the electric field is radially oriented and essentially orthogonal to the magnetic field inside the ionization and charging unit. The arrangement shown here is particularly suited for a self-heating of the ionization and charging unit, as the flow of thermal energy through the webs is minimal.

FIG. 4 shows a schematic of an amplifier circuit for an embodiment of the apparatus. A high voltage source UHV is connected to anode and cathode of the gauge, i.e. to anode and cathode of the ionization and charging unit, at the connection points indicated in the left part of the schematic. The current delivered to the cathode is measured as a voltage drop over a shunt resistor, in this case a shunt resistor of 47 kΩ is selected. An amplifier 15, in this case an operational amplifier, forms the active component of the amplifier circuit. An operational amplifier fulfilling the high requirements for measurements on a short time scale of nanoseconds is commercially available under the name “OPA 859” from Texas Instruments. The amplifier circuit shown here is suitable for OPA 859. Voltage supply of +/−2.5 Volts as well as the amplifier circuit are inside a shielded region connected to ground, the flange of the apparatus and the cathode of the ionization and charging unit. At the output side, an oscilloscope or any analyzing device may be connected in order to detect particles based on an AC component or a transient of the measured current. The voltage signal on the output side is a signal indicative for the time course of the current flowing from or to the anode and/or from and to the cathode. The amplifier circuit shown here acts as a buffer amplifier, such that the current extracted on the output side, for example for operating an oscilloscope, does not affect the side of the ionization and charging unit and thus allows that very tiny and fast oscillating currents may be observed.

The voltage supply preferably delivers a very stable voltage over time, as any oscillations in the voltage supply may deteriorate the signal measured at the output side of the amplifier circuit. A smoothing of the time course of the voltage may be achieved by connecting inductors in series and/or capacitors in parallel to a voltage source.

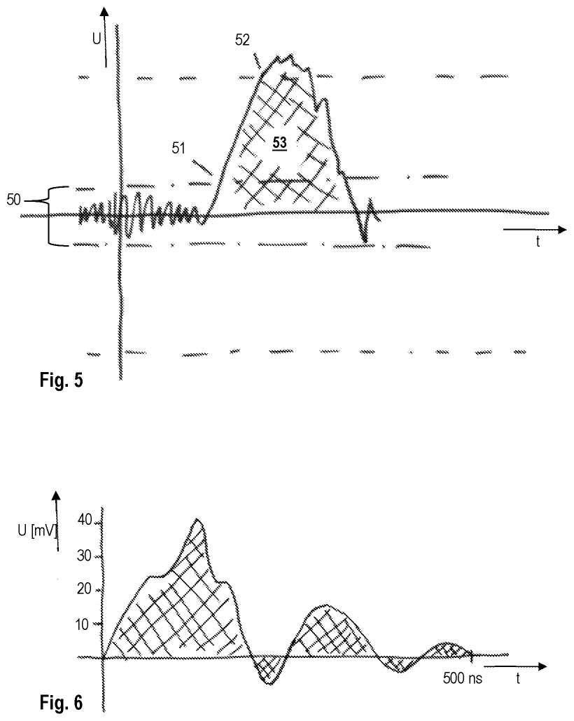

FIG. 5 indicates schematically, in time-voltage-diagram, elements of a signal indicative for a measured current, which may be used as signature to decide, whether a particle has been detected, or possibly to classify the particles with respect to their size or composition. Horizontally, the time axis t is displayed. Vertically, a voltage signal U, here in arbitrary units, is displayed. The voltage signal is indicative for a current measured in connection with the anode or the cathode of the apparatus and may, as an example, be produced by an amplifier circuit as shown in FIG. 4. In the time where no particles are detected, a noise signal inside a typical noise band 50 is observed. The noise band is indicated by dash-dotted lines. A first indicator for the impact of a particle on one of the electrodes is that the signal leaves the noise band 51. A second indicator for the impact of a particle is that the signal reaches a trigger level 52, which may be a trigger level reflecting the size of the particles that shall be detected. Here, a trigger level is indicated by dashed lines. A trigger level for positive as well as for negative amplitudes is defined here. A third indicator for the impact of a particle is an integral of the signal. Here, the integral is indicated as the cross-hatched area under the signal curve in a region exhibiting the first and second indicator as discussed before and taking into account the time in which the signal stays positive. Alternatively, the integrals could be calculated over a predefined time interval or a time interval, the end of which is defined by another criterion. If positive and negative values of the signal occur in the time interval integrated, the absolute value or the square of the value of the signal may be integrated in order to have an indicator for the size of the particle's impact. From the combination of all three indicators a decision may be made whether a particle count or no particle count shall be contributed to the signal observed.

FIG. 6 shows a signal as may be observed after the impact of a particle on one of the electrodes and displays a typical signature. The signal has the form of a decaying oscillation, with positive half-waves being significantly larger than the negative half-waves. Two complete oscillations are observed on a time-scale shorter than 500 ns.

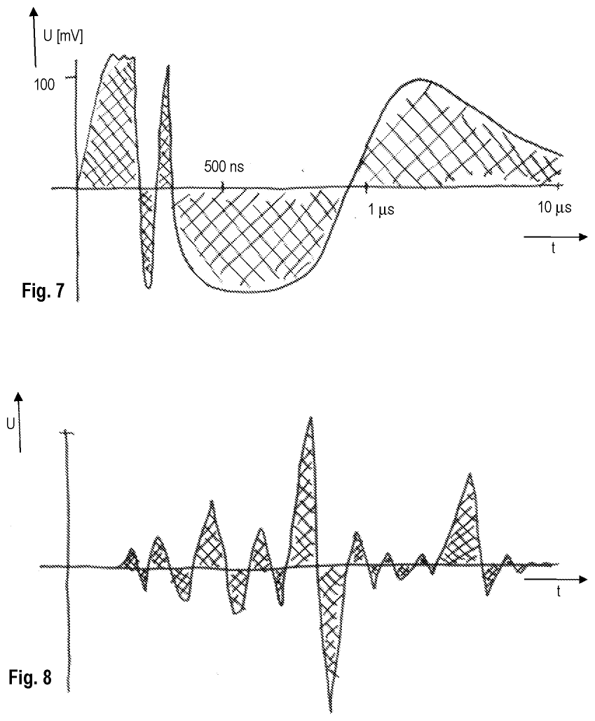

FIG. 7 shows another example of a signal as may be observed after the impact of a particle on one of the electrodes. Here, the time scale is non-linear in order to show a longer time range up to 10 microseconds together with the short timescale behaviour in the first 500 nanoseconds. At the beginning, the signal rises fast and saturates above 100 mV. Then, several oscillations occur, first on a short time scale and then comparably slow oscillations follow.

FIG. 8 shows a disturbance that may be actively excluded from being counted as particle impact by appropriate signal processing. The high amplitude of the signal may leave the noise band and reach the trigger level. However, this signal does not have the asymmetry in time typical for a signal created by a particle impact at a time 0 defined by the first impact of the particle to one of the electrodes.

### LIST OF REFERENCE SYMBOLS

10 apparatus for detecting particles
11 ionization and charging unit
12 anode
13 cathode
14 hydrodynamic lens
15 amplifier (high gain AC amplifier)
16 web
17 pipe (delivery pipe or discharge pipe)
20 gas flow
50 noise band
51 signal leaves noise band (first indicator)
52 signal reaches trigger level (second indicator)
53 integral (third indicator)
M magnet
N north pole of a permanent magnet
S south pole of a permanent magnet
U_{HV} high voltage source
U voltage (of measured signal)
t time

1. A method for detecting particles in a gas of a process environment present in a process chamber, the method comprising the steps of:
guiding the gas, which potentially carries with it one or more particles, into an ionization and charging unit (11) being in fluid communication with the process chamber, wherein the ionization and charging unit has an anode (12) and a cathode (13) and is adapted and configured to at least partly ionize said gas and to charge at least some of said particles;
igniting and sustaining a discharge in said gas by applying a voltage between said anode and said cathode of the ionization and charging unit;
measuring a current flowing from or to the anode and/or from and to the cathode;
detecting the particles based on an AC component or a transient of the measured current.

2. The method of claim 1, further comprising a step of classifying the particles based on a signature of the AC component or of the transient of the measured current.

3. The method of claim 1, wherein the particles to be detected have a mass of more than 1000 Dalton.

4. The method of claim 1, wherein an electric field between the anode and the cathode has a strength in a range from 300 to 3000 kV/m.

5. The method of claim 1, wherein the gas is focussed into an opening of the ionization unit by means of a hydrodynamic lens (14), wherein the hydrodynamics lens optionally may be heated to a temperature above the temperature of its surrounding.

6. The method of claim 1, wherein the ionization and charging unit (11) has an inlet at one end and an outlet at an other end, so that the gas can pass through the ionization and charging unit.

7. The method of claim 1, wherein the gas is in the group comprising air, nitrogen, oxygen, hydrogen, helium, and argon.

8. The method of claim 1, wherein a pressure of the gas, at which pressure the detection takes place, is less than atmospheric pressure, in particular down to 10⁻⁸ mbar.

9. The method of claim 1, wherein the step of detecting comprises amplifying the charging current and/or discharging current by means of an AC amplifier circuit having a bandwidth of at least 500 MHz.

10. The method of claim 1, further comprising the step of indicating that particles have been detected when the AC component or the transient exceeds a predetermined threshold, and/or indicating that a certain class of particles has been detected when an associated signature, in particular from one or more predetermined signatures, of the AC component or of the transient has been detected.

11. An apparatus for detecting particles in a gas of a process environment in a process chamber, the apparatus comprising:
an ionization and charging unit (11) with an anode (12) and a cathode (13), adapted and configured to at least partly ionize said gas and to charge at least some of said particles;
a voltage source connected between said anode and said cathode of the ionization and charging unit;
a current measurement unit adapted to measure a current from or to the anode and/or from and to the cathode;
a particle classification unit adapted to detect the particles based on an AC (alternating current) component or a transient of the measured current.

12. The apparatus of claim 11, wherein the particle classification unit is further adapted to classify the particles based on a signature of the AC component or of the transient of the measured charging current and/or discharging current.

13. The apparatus of claim 11, wherein the particles to be detected have a mass of more than 1000 Dalton.

14. The apparatus of claim 11, adapted such that an electric field between the anode and the cathode can have a strength in a range from 300 to 3000 kV/m.

15. The apparatus of claim 11, further comprising a hydrodynamic lens (14) adapted to focus the gas into an opening of the ionization and charging unit, wherein the hydrodynamics lens optionally is in thermal contact to heating means for increasing a temperature of the hydrodynamic lens with respect to its surrounding.

16. The apparatus of claim 11, wherein the ionization and charging unit has an inlet at one end and an outlet at an other end, so that the gas can pass through the ionization and charging unit.

17. The apparatus of claim 11, further comprising a fast, high gain AC amplifier for amplifying the charging current and/or discharging current,
wherein an amplifier circuit having a bandwidth of at least 500 MHz.

18. The apparatus of claim 11, further comprising an output for a signal indicating that particles have been detected when the AC component or the transient exceeds a predetermined threshold, and/or indicating that a certain class of particles has been detected when an associated signature, in particular from one or more predetermined signatures, of the AC component or of the transient has been detected.

19. A coating system, etching system or lithographic system comprising an apparatus of claim 11, wherein the apparatus is in particular located within a delivery pipe for delivering the gas to the processing chamber or within a discharge pipe for discharging the gas from the process chamber.

20. The coating, etching system or lithographie system of claim 19 being a system for performing CVD, PVD, PECVD or ALD processes or an epitaxy system.

21. A use of an ionization unit for detecting particles in a gas of a process environment within a process chamber, wherein the particles to be detected in particular have a mass of more than 1000 Dalton.

22. The use of the ionization unit according to claim 21, wherein an ambient pressure at which the detection takes place is less than atmospheric pressure, in particular down to 10⁻⁸ mbar.

23. The use of the ionization unit according to claim 21, wherein the gas is in the group comprising air, nitrogen, oxygen, hydrogen, helium, and argon.
